(19) United States
(12) Patent Application Publication
(10) Pub. No.: US 2005/0166687 A1
(43) Pub. Date: Aug. 4, 2005

(54) Method and device for detecting low rigidity

(75) Inventors: Kenji Kaneko, Ibaraki (JP); Kazuhito Yokoi, Ibaraki (JP); Shuuji Kajita, Ibaraki (JP); Fumio Kanehiro, Ibaraki (JP); Kiyoshi Fujiwara, Ibaraki (JP); Hirohisa Hirukawa, Ibaraki (JP); Shigehiko Ota, Tokyo (JP); Toshikazu Kawasaki, Tokyo (JP); Kazuhiko Akachi, Tokyo (JP); Takakatsu Isozumi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Nat. Inst. Of Avdanced Industr. Science And Tech., Tokyo (JP); Kawada Industries, Inc., Tokyo (JP)

(21) Appl. No.: 10/500,853

(22) PCT Filed: Jan. 17, 2003
(86) PCT No.: PCT/JP03/00358

(51) Int. Cl. G01L 1/02

(52) U.S. Cl. 73/862.581

(57) ABSTRACT

A method for detecting a low rigid force and a device therefor are provided in that even a large impact force is applied, by integrating an impact absorbing unit with the force detection mechanism, a force detection mechanism may not be damaged.

To that end, between a pair of substrates 2a and 2b opposing each other and undergoing displacement in a direction changing the space between them by an impact force applied thereto, at least one absorption detection mechanism 3 integrally including an impact absorbing unit 4 and a force detecting unit 5 is interposed, so that a force applied between both the substrates 2a and 2b is detected by the force detecting unit 5 while an impact force applied between both the substrates 2a and 2b being absorbed by an elastic force of the impact absorbing unit 4.

### TECHNICAL FIELD

The present invention relates to methods for detecting a low rigid force and devices therefor, and in particular relates to a method for detecting a low rigid force and a device therefor suitably used for measuring a force and a torque applied between a leg section of a legged robot and a contact plane for controlling the stable attitude of the legged robot.

### BACKGROUND ART

In order to measure a force applied outside by a robot manipulator and a ground contact force of a legged robot, a force detecting device has been used in that a stress is measured by bonding a strain gauge, for example, on a mechanism with comparatively high rigidity so as to detect a force or a torque. Since in order to control positions and forces of a robot with high accuracy, a device and a system capable of detecting forces without drastically reducing the rigidity of the entire robot have been demanded, this detecting device has been suited to such a demand.

However, the problem of the conventional technique mentioned above is that when a large impact force is applied, the detecting device is liable to be damaged. In particular, when this force detecting device is applied to measurement of the ground contact force of a legged robot, since a force proportional to the total weight of the robot and the collision speed thereof is applied to the detecting device, there is quite a possibility that the force detecting device is damaged, requiring frequent replacements.

On the other hand, for some kinds of a robot, especially for a legged robot, a device and a system having a low-rigid impact absorbing mechanism, such as a rubber bush mechanism, has been used for absorbing an impact force produced upon collision between a link and an outside environment, and the device is going to be promising. When such a mechanism is used, the rigidity of the entire mechanism is relatively reduced, so that the necessity for the conventional high rigid force detecting mechanism is reduced.

### DISCLOSURE OF INVENTION

It is a technical object of the present invention to provide a technique for detecting a low rigid force in that even a large impact force is applied, a force detection mechanism may not be damaged by integrating impact absorbing means with the force detection mechanism.

In order to solve the above object, according to the present invention, a method for detecting a low rigid force is provided, which includes the steps of preparing a pair of substrates opposing each other and undergoing displacement in a direction changing the space between the substrates by an impact force applied thereto; interposing at least one absorption detection mechanism between the substrates, the absorption detection mechanism being made by integrating impact absorbing means and force detecting means in one body; and detecting a force applied between the substrates by the force detecting means while absorbing an impact force applied between the substrates by elasticity of the impact absorbing means.

According to the method of the present invention, since a force applied between both the substrates is detected by the force detecting means while an impact force is absorbed by the impact absorbing means, even a large impact force is applied, the detecting device may not be damaged.

According to a specific method of the present invention, the impact absorbing means is a columnar low rigid member having rubber elasticity while the force detecting means is a displacement sensor for detecting a force produced in accordance with a strain of the low rigid member in a longitudinal direction.

According to another specific method of the present invention, the impact absorbing means is a pressure chamber having working fluid enclosed therein while the force detecting means is a pressure sensor for detecting a pressure in the pressure chamber as a force.

In order to use the method, according to the present invention, a low rigid force detecting device is provided, which includes a pair of substrates opposing each other and undergoing displacement in a direction changing the space between the substrates by an impact force applied thereto; and at least one absorption detection mechanism interposed between the substrates, wherein the absorption detection mechanism integrally includes impact absorbing means for absorbing an impact force applied between the substrates by an elastic force and force detecting means for detecting a force applied between the substrates.

According to one specific embodiment of the present invention, the impact absorbing means is constructed by a columnar low rigid member having rubber elasticity while the force detecting means is composed of a displacement sensor for detecting a force produced in accordance with a strain of the low rigid member in a longitudinal direction.

According to another specific embodiment of the present invention, the impact absorbing means is a pressure chamber disposed between both the substrates and having working fluid enclosed therein while the force detecting means is a pressure sensor for detecting a pressure in the pressure chamber as a force.

In the present invention, while a pair of the substrates have degrees of freedom with regard to a relative displacement in the Z-axial direction and relative rotational displacements about the X- and Y-axis, a relative rotational displacement about the Z-axis and relative displacements in the X- and Y-axial directions are restricted.

Specifically, one substrate of the pair of the substrates includes arc concave portions, respectively formed in a plurality of sides, and ribs formed on part of the internal surface of each of the concave portions while the other substrate includes columnar stoppers which are fitted into the concave portions so as to come in contact with the ribs, so that the substrates are restricted in a relative rotational displacement about the Z-axis and relative displacements in the X- and Y-axial directions while having degrees of freedom with regard to a relative displacement in the Z-axial direction and relative rotational displacements about the X- and Y-axis.

### BRIEF DESCRIPTION OF THE DRAWINGS

FIG. 1 is a perspective view schematically showing a low rigid force detecting device according to a first embodiment of the present invention.

FIG. 2 is a perspective view showing a second embodiment of the same.

FIG. 3 is a sectional view of FIG. 2.

FIG. 4 is a perspective view schematically showing a low rigid force detecting device according to a third embodiment of the present invention.

FIG. 5 is a perspective view showing a fourth embodiment of the same.

FIG. 6 is a perspective view showing a fifth embodiment of the same.

### BEST MODE FOR CARRYING OUT THE INVENTION

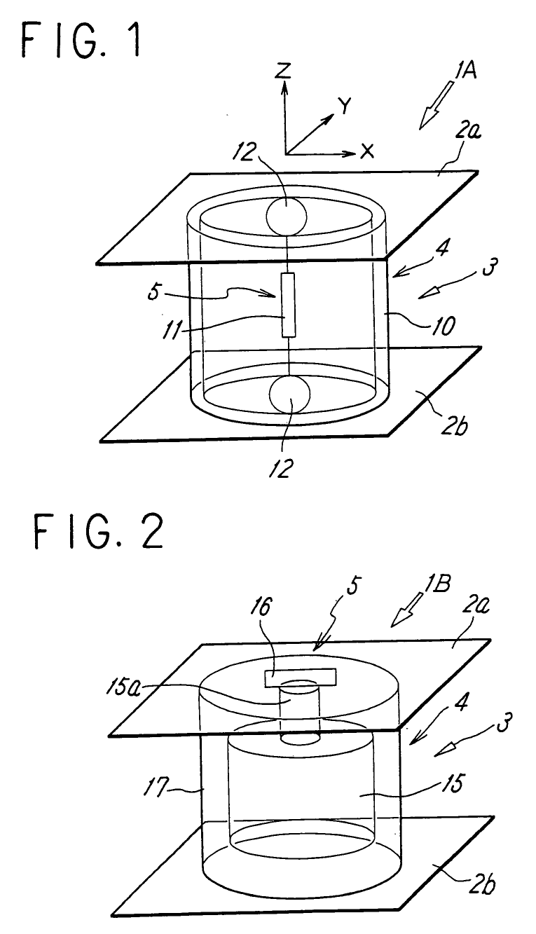

FIG. 1 basically shows a low rigid force detecting device according to a first embodiment of the present invention. A detecting device 1A includes a pair of substrates 2a and 2b opposing each other and an absorption detecting mechanism 3 interposed between the substrates 2a and 2b.

Both the substrates 2a and 2b are arranged movably in a direction changing the spacing between the substrates while substantially maintaining the parallelism between them. In other words, these substrates 2a and 2b are relatively movable in the Z-axial direction orthogonal to the substrates 2a and 2b, and with regard to relative displacements in other directions i.e., in the X-axial and Y-axial directions orthogonal to each other in parallel with the substrates 2a and 2b, and also with regard to rotational displacements about the X-axial, Y-axial, and Z-axial directions, rigidity is increased by the restriction by means such as a stopper (not shown). However, the displacements about the X-axial, and Y-axial directions may also have a slight degree of freedom.

On the other hand, the absorption detecting mechanism 3 is constructed by integrating impact absorbing means 4 and force-detecting means 5 in one body. Among these, the impact absorbing means 4 is made of a hollow cylindrical-columnar low rigid member 10 having rubber elasticity like a rubber bush. The low rigid member 10 is attached between both the substrates 2a and 2b so as to absorb an impact force applied between the substrates 2a and 2b by an elastic strain of the low rigid member 10 in the longitudinal direction. Also, the force-detecting means 5 is composed of a displacement sensor 11 for detecting a displacement in the straight direction. While the displacement sensor 11 is accommodated inside the low rigid member 10, both ends of the displacement sensor 11 are connected to the substrates 2a and 2b via ball joints 12 and 12, respectively, so that a linear force applied between the substrates 2a and 2b in the Z-axial direction can be detected by measuring a strain of the low rigid member 10 in the longitudinal direction by the displacement sensor 11. A plurality the absorption detecting mechanisms 3 may be provided.

The low rigid force detecting device 1A structured as described above can detect a force applied between the substrates 2a and 2b by measuring a strain in the longitudinal direction produced by the compression of the low rigid member 10 by the displacement sensor 11 while an impact force applied between the substrates 2a and 2b being absorbed by an elastic force of the low rigid member 10. Hence, even a large impact force is applied between the substrates 2a and 2b, the detecting device may not be damaged.

In addition, the low rigid member 10 may have any material and shape, like hollow or rigid, as long as it can absorb an impact by rubber elasticity. On the other hand, the displacement sensor 11 may be of any types such as a linear potentiometer, a linear encoder, or a laser displacement sensor, as long as it can detect a linear displacement. The displacement sensor 11 is not necessarily arranged inside the low rigid member 10, and it may be arranged outside the low rigid member 10.

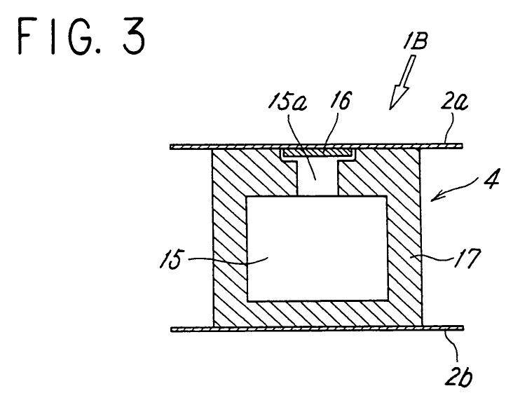

FIGS. 2 and 3 show a second embodiment of the present. Points, in which a detecting device 1B according to the second embodiment differs from the detecting device 1A according to the first embodiment, are that the impact absorbing means 4 of the absorption detecting mechanism 3 is constructed by a pressure chamber 15, and the force-detecting means 5 is constructed by a pressure sensor 16. That is, between a pair of the substrates 2a and 2b arranged substantially in parallel with each other, a casing 17 made of a material with non-porousness, flexibility, and preferably rubber elasticity, like rubber or a synthetic resin, is attached. Working fluid, such as air, water, and oil, is enclosed in the casing 17 to form the pressure chamber 15. On one substrate 2a, the pressure sensor 16 is attached for detecting a pressure of the pressure chamber 15 as a force, and the pressure sensor 16 and the pressure chamber 15 are connected together with a connection path 15a.

In the detecting device 1B, while an impact force applied between both the substrates 2a and 2b being absorbed with elastic deformation of the pressure chamber 15, a force in a linear displacement direction applied between both the substrates 2a and 2b is detected by measuring a pressure in the pressure chamber 15 with the pressure sensor 16.

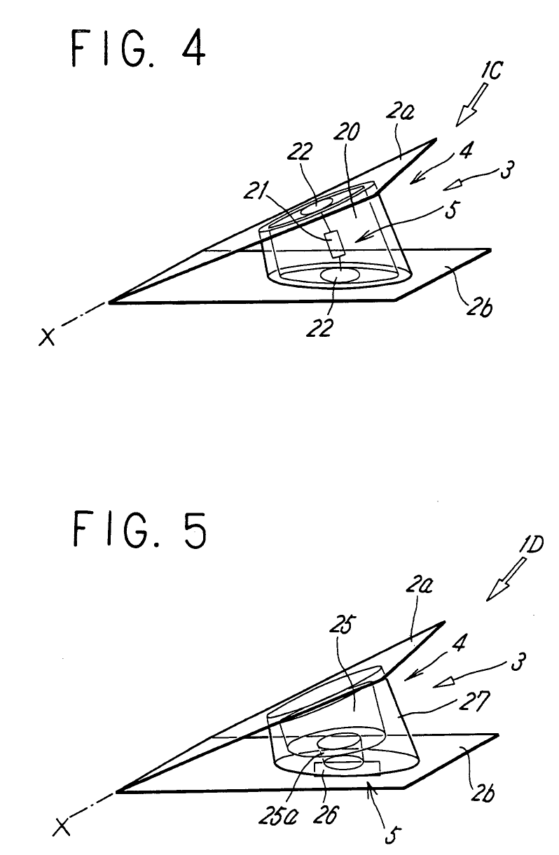

FIG. 4 shows a third embodiment of the present invention. A detecting device 1C according to the third embodiment differs from the first embodiment with regard to the detection of a force in a rotational direction. That is, the two substrates 2a and 2b are arranged relatively and changeably in a direction changing an angle (space) between the substrates about the X-axis. Between the substrates 2a and 2b, at least one absorption detecting mechanism 3 made by integrating the impact absorbing means 4 and the force-detecting means 5 in one body is interposed. It is not always that the substrates 2a and 2b be connected together along the X-axis. The impact absorbing means 4 is constructed by a hollow columnar low-rigid member 20 with rubber elasticity, and both ends thereof are obliquely cut off in accordance with inclinations of both the substrates 2a and 2b. Also, the force-detecting means 5 is constructed by a displacement sensor 21 capable of measuring a displacement in a rotational direction, and within the low-rigid member 20, the displacement sensor 21 is accommodated, and both ends of the displacement sensor are connected to the substrates 2a and 2b with ball joints 22 and 22 therebetween, respectively. By measuring a strain in the rotational direction of the low-rigid member 20 with the displacement sensor 21, a force in a rotational direction, i.e., a torque applied between the substrates 2a and 2b can be detected. Other structures are substantially the same as those of the first embodiment.

According to the third embodiment, the low-rigid member 20 may also be arbitrary in material and shape as long as it can absorb an impact force with rubber elasticity. The displacement sensor 21 may also be of any types, such as a rotary potentiometer and a rotary encoder, as long as it can detect a rotational displacement. The displacement sensor 21 is not necessarily arranged inside the low rigid member 20, and it may be arranged outside the low rigid member 20.

FIG. 5 shows a fourth embodiment of the present invention. Points, in which a detecting device 1D according to the fourth embodiment differs from the detecting device 1C according to the third embodiment, are that the impact absorbing means 4 is constructed by a pressure chamber 25, and the force-detecting means 5 is constructed by a pressure sensor 26. That is, between a pair of the substrates 2a and 2b rotatable about the X-axis in a rotational direction, a casing 27 made of a material with non-porousness, flexibility, and preferably rubber elasticity is attached. Working fluid, such as air, water, and oil, is enclosed in the casing 27 to form the pressure chamber 25. On one of the substrates 2a and 2b, the pressure sensor 26 is attached for detecting a pressure of the pressure chamber 25 as a force, and the pressure sensor 26 and the pressure chamber 25 are connected together with a connection path 25a. Other structures are substantially the same as those of the second embodiment.

Also, in the detecting device 1D, while an impact force applied between both the substrates 2a and 2b being absorbed with an elastic force of the pressure chamber 25, a force in a rotational direction applied between both the substrates 2a and 2b is detected by measuring a pressure in the pressure chamber 25 with the pressure sensor 26.

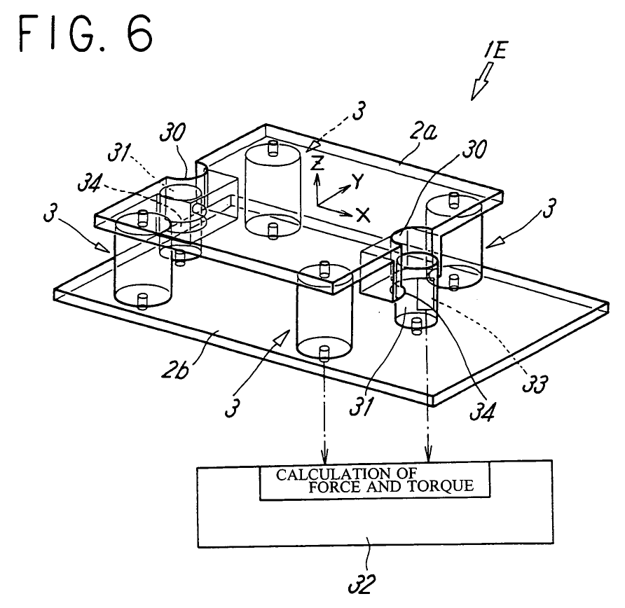

FIG. 6 shows a fifth embodiment of the present invention. In a detecting device 1E, between the first and second substrates 2a and 2b, a plurality of the absorption detecting mechanisms 3 are provided. According to the embodiment, between both the substrates 2a and 2b, four absorption detecting mechanisms 3 are arranged at four corners of the square substrate, respectively. These absorption detecting mechanisms 3 may be either the combination of the low rigid member 10 and the displacement sensor 11 like in the first embodiment or the combination of the pressure chamber 15 and the pressure sensor 16 like in the second embodiment, and alternatively may use components in cross combination.

In a pair of sides of the first substrate 2a opposing each other, circular arc concave portions 30 are respectively formed at the center while on the second substrate 2b, columnar stoppers 31 are arranged so as to engage with the concave portion 30. By the combination of the concave portion 30 and the stopper 31, displacements due to the relative rotation about the Z-axis and due to parallel shifts in the X- and Y-axial directions are restricted so as to have high rigidity. The internal surface of the concave portion 30 is provided with a rib 34 having an arc section and formed in part of the internal surface for coming into arc contact with the external surface of the stopper 31. Hence, both the substrates 2a and 2b are relatively movable in the Z-axial direction while having some degree of freedom in relative rotational displacements about the X-axis and the Y-axis due to the rib 34, so that the rigidity is slightly reduced. In the drawing, reference numeral 32 denotes a control unit in that from a signal detected by the absorption detecting mechanism 3, a force or a torque is calculated while a control signal is obtained for a robot, etc. Such a control unit may also be provided in the detecting devices according to the first to fourth embodiments.

The detecting device 1E structured as described above may be suitably used for leg mechanisms of legged robots, for example. A force applied between both the substrates 2a and 2b can be detected by measuring a longitudinal displacement due to the deformation of the low rigid member 10 with the displacement sensor 11 in the case where the absorption detecting mechanism 3 is combination of the low rigid member 10 and the displacement sensor 11, as well as by measuring a pressure in the pressure chamber 15 with the pressure sensor 16 in the case where the absorption detecting mechanism 3 is combination of the pressure chamber 15 and the pressure sensor 16.

In this case, if the stress distribution of a foot sole is approximated by a trapezoid, a force in the Z-axial direction, i.e., a vertical force Fz can be obtained using the formula:
Fz=α(P1+P2+P3+P4)
where α is the proportionality coefficient; and P1, P2, P3, and P4 are the forces measured with the four absorption detecting mechanisms 3, respectively. Specifically, P1 is the force measured with the absorption detecting mechanism 3 arranged at a position (X: positive, Y: negative) on the X-Y plane; and similarly, P2, P3, P4 are the forces measured with the absorption detecting mechanisms 3 located at positions (X: positive, Y: positive), (X: negative, Y: positive), and (X: negative, Y: negative) on the X-Y plane, respectively.

Also, moments Mx and My about the X-axis and the Y-axis can be obtained from:
Mx=β(P1−P2−P3+P4)
My=β(P1+P2−P3−P4).

Furthermore, horizontal forces Fx and Fy in the X- and Y-axial directions, which are high-rigidity directions, can be measured with a conventional technique, such as bonding a strain gauge 33 on the stopper 31. A torque about the vertical axis (the Z-axis), which is a high-rigidity rotational component, can be also measured in a similar way with a strain gauge bonded on the stopper. The force and torque information obtained in such a manner is entered to the control unit 32 so as to control various desired items.

Thus, the detecting device 1E according to the fifth embodiment is suitably used for places requiring anisotropic characteristics, where while an impact force needs to be absorbed in the vertical direction, high rigidity is required in the horizontal direction instead of the impact absorption, such as a leg portion of a legged robot. Alternatively, the device may be used for mechanisms, other than the legged robot, requiring low rigidity in a specific direction and high rigidity in another direction as well.

As described above in detail, according to the present invention, a method for detecting a low rigid force and a device therefor can be obtained in that even a large impact force is applied, force detection means may not be damaged by integrating impact absorbing means with the force detection means.

1. A method for detecting a low rigid force, comprising the steps of:
preparing a pair of substrates opposing each other and undergoing displacement in a direction changing the space between the substrates by an impact force applied thereto;
interposing at least one absorption detection mechanism between the substrates, the absorption detection mechanism being made by integrating impact absorbing means and force detecting means in one body; and
detecting a force applied between the substrates by the force detecting means while absorbing an impact force applied between the substrates by elasticity of the impact absorbing means.

2. The method according to claim 1, wherein the impact absorbing means comprises a columnar low rigid member having rubber elasticity while the force detecting means comprises a displacement sensor for detecting a force produced in accordance with a strain of the low rigid member in a longitudinal direction.

3. The method according to claim 1, wherein the impact absorbing means comprises a pressure chamber having working fluid enclosed therein while the force detecting means comprises a pressure sensor for detecting a pressure in the pressure chamber as a force.

4. A low rigid force detecting device, comprising:
a pair of substrates opposing each other and undergoing displacement in a direction changing the space between the substrates by an impact force applied thereto; and
at least one absorption detection mechanism interposed between the substrates,
wherein the absorption detection mechanism integrally comprises impact absorbing means for absorbing an impact force applied between the substrates by an elastic force and force detecting means for detecting a force applied between the substrates.

5. The device according to claim 4, wherein the impact absorbing means comprises a columnar low rigid member having rubber elasticity while the force detecting means comprises a displacement sensor for detecting a force produced in accordance with a strain of the low rigid member in a longitudinal direction.

6. The device according to claim 4, wherein the impact absorbing means comprises a pressure chamber disposed between both the substrates and having working fluid enclosed therein while the force detecting means comprises a pressure sensor for detecting a pressure in the pressure chamber as a force.

7. The device according to any one of claims 4 to 6, wherein while a pair of the substrates have degrees of freedom with regard to a relative displacement in the Z-axial direction and relative rotational displacements about the X- and Y-axis, a relative rotational displacement about the Z-axis and relative displacements in the X- and Y-axial directions are restricted.

8. The device according to claim 7, wherein one substrate of the pair of the substrates comprises arc concave portions, respectively formed in a plurality of sides, and ribs formed on part of the internal surface of each of the concave portions while the other substrate comprises columnar stoppers which are fitted into the concave portions so as to come in contact with the ribs, and
wherein with the concave portions, the ribs, and the stoppers, the substrates are restricted in a relative rotational displacement about the Z-axis and relative displacements in the X- and Y-axial directions while having degrees of freedom with regard to a relative displacement in the Z-axial direction and relative rotational displacements about the X- and Y-axis.
